(19) United States
(12) Patent Application Publication
(10) Pub. No.: US 2003/0016654 A1
(43) Pub. Date: Jan. 23, 2003

(54) Network and access protection in optical networks

(76) Inventors: Jayanta Das, Morganville, NJ (US); Ganesh Lakshminarayana, Plainsboro, NJ (US); Kuo-Ming Lee, Morganville, NJ (US); Roman Antosik, Colts Neck, NJ (US); Scott Kaminski, Highlands, NJ (US); Jithamithra Sarathy, Atlantic Highlands, NJ (US); Boris Stefanov, Gillette, NJ (US); Ronald Simprini, Red Bank, NJ (US); Bharat Dave, Howell, NJ (US)

Correspondence Address: KAPLAN & GILMAN , L.L.P., 900NROUTE 9 NORTH, WOODBRIDGE, NJ, 07095, US

(21) Appl. No.: 10/172,370

(22) Filed: Jun. 14, 2002

Related U.S. Application Data
(60) Provisional application No. 60/298,190, filed on Jun. 14, 2001.

(51) Int. Cl. H04L 12/28

(52) U.S. Cl. 370/351

(57) ABSTRACT

Method and apparatus are presented which define generic cross-connect primitives that enable the implementation of 1+1 protection in a mesh configured optical network. Such primitives are capable of supporting both 1+1 network protection as well as 1+1 client/access protection, or both. Further, the invention supports multicast applications at no additional architectural cost.

### CROSS REFERENCE TO OTHER APPLICATIONS

This application claims the benefit of U.S. Provisional Patent Application Serial No. 60/298,190 filed on Jun. 14, 2001.

### TECHNICAL FIELD

This invention relates to optical communications, and in particular to a method of implementing protection for mesh configured optical data networks.

### BACKGROUND OF THE INVENTION

Mesh configured data networks offer numerous advantages over data networks configured as rings. In the past, much of the traffic over computer data networks originated and terminated in a few geographic locations. Thus, in the United States, for example, the continental land mass was traversed by a small number of interlocking rings stretching from coast to coast. As utilization of data networks continues to increase, and traffic tends to be evenly distributed geographically however, the ring configuration no longer best mirrors the actual traffic.

Given this history, existing SONET optical networks are primarily configured using ring architectures. The provision of 1+1 network protection thus reduces bandwidth utilization by 50%. The promise of WDM using optical switches is to enable a mesh network with much higher bandwidth utilization but providing the same level of protection as well as various levels of differentiated services.

The challenge is thus to develop a switch architecture to realize the above-stated promise, which as yet does not exist.

What is needed is a switching architecture that will enable implementation of 1+1 protection, as is currently available in SONET ring networks, in an optical mesh configured network.

### SUMMARY OF THE INVENTION

Method and apparatus are presented which define simple and generic cross-connect primitives that enable the implementation of 1+1 protection in a mesh configured optical network. Such primitives are capable of supporting both 1+1 network protection as well as 1+1 client/access protection, or both. Further, the invention supports multicast applications at no additional architectural cost.

### BRIEF DESCRIPTION OF THE DRAWINGS

FIG. 1 depicts 1+1 network protection in optical networks according to the present invention;

FIG. 2 depicts an “atomic cross connect”;

FIG. 3 depicts “1+1 cross connect” in the ingress node of FIG. 1;

FIG. 4 depicts “1+1 cross connect” in the egress node of FIG. 1;

FIG. 4A depicts examples of the use of the primitives of FIGS. 2-4 in a data network;

FIG. 5 depicts failures in the service lightpath as protected by 1+1 network protection according to the present invention;

FIG. 6 depicts access protection at an ingress node;

FIG. 7 depicts access protection at an egress node;

FIG. 8 illustrates 1+1 access protection without network protection;

FIG. 9 illustrates combining 1+1 access protection and network protection;

FIG. 10 depicts a bidirectional cross-connect roll;

FIG. 11 illustrates shared network protection according to the present invention with no access protection;

FIG. 12 depicts an access cross-connect roll executed at an ingress node;

FIG. 13 depicts an access cross-connect roll executed at an egress node;

FIG. 14 depicts combining 1+1 access protection with shared network protection;

FIG. 15 depicts a 1×2 multicast configuration; and

FIG. 16 depicts a 1×4 multicast configuration.

### DETAILED DESCRIPTION OF THE PREFERRED EMBODIMENTS

In order to efficiently communicate the present invention, certain terms of art will be used. The following Table A presents these terms and their definitions.

TABLE A
TERMS OF ART

| | |
|---|---|
| Atomic cross- | Two identical cross-connects in the switching fabrics |
| connect | SFA, SFA executed with a single command. |
| 1 + 1 cross- | A cross-connect executed in one switching fabric only |
| connect | via two different paths of the redundant switch fabric. |
| 1 + 1 network | A service lightpath protected by a second link and |
| protection | node disjoint protection lightpath. |
| Service lightpath | One of two lightpaths currently selected at egress node |
| | to the Client NE in 1 + 1 network protection or shared |
| | network protection. |
| Protection | One of two lightpaths that is not selected at egress |
| lightpath | node to the client NE in a 1 + 1 network protection |
| | lightpath. The protection lightpath is selected at the |
| | egress node once a failure is occurred at the service |
| | lightpath. |
| 1 + 1 access | Two independent signals from a client device |
| protection | terminated on two separate input ports. If one of the |
| | signals fails, the other signal is selected to be carried |
| | over the network. |
| Protection meta- | An optical end-to-end path not cross-connected at |
| lightpath | provisioning. The path is cross-connected at the time |
| | of a failure of the service lightpath it protects. |
| Lightpath ID | A unique end-to-end lightpath identifier generated by |
| | the network |

Similarly, the acronyms listed in Table B below will be used herein, standing for the following phrases or concepts:

TABLE B
ACRONYMS

| | |
|---|---|
| ACT | Active |
| AD | Auto Discovery |
| AID | Access Identifier |
| BUSY | The port is cross-connected |
| DISC | The transport neighbor of this port has been discovered |
| DISC_PROH | The discovery of the transport neighbor is prohibited. |
| IS | In Service |
| NOT_DISC | The transport neighbor of this port has not been |
| | discovered |
| OOS | Out-of-Service |
| PROT | The port is reserved for protection |

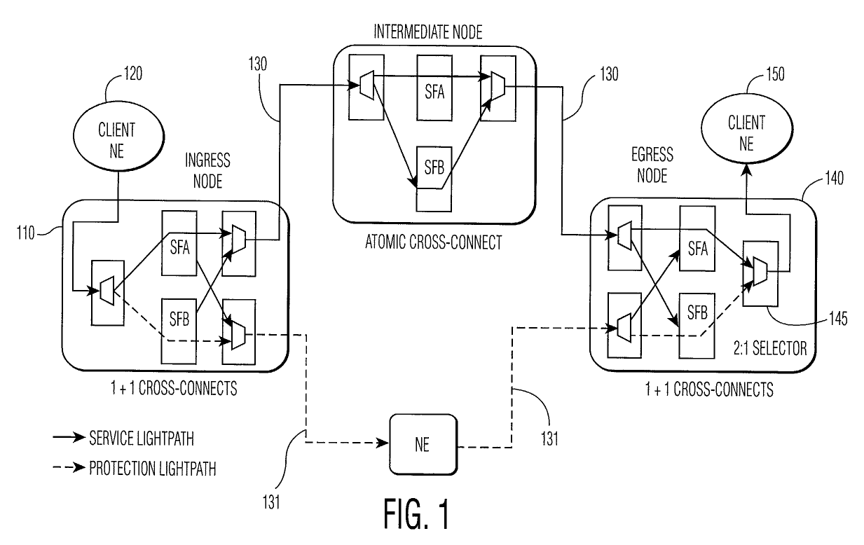

FIG. 1 illustrates an exemplary structure for 1+1 network protection in optical networks. In 1+1 network protection, a selected service lightpath is protected by a standby protection lightpath. In the Ingress Node 110, the signal from the Client Network Element (“NE”) 120 is bridged to both lightpaths 130 and 131 and transmitted through the network to the Egress Node 140. In the Egress Node, the 2:1 selector 145 selects one of the signals to send to the Client NE 150. As can be seen, at the ingress node incoming traffic splits into two lightpaths 130 and 131, and at the egress node these two lightpaths converge to output to a client NE 150. At intermediate nodes traffic comes in via one lightpath and exits via a single lightpath. These structures can be used as basic building blocks, or primitives, for the implementation of protection in an optical mesh network. The present invention implements a redundant switching fabric, as well as redundant connections to and from that redundant switching fabric. That redundancy is exploited to create a 1+1 cross connect structure for access and network protection.

In the traditional ring structure, traffic flows along two directions, but always enters from and exits via each of the same two neighboring network elements. Thus traffic moves in virtually a straight line, and traffic that enters a network node via an immediately upstream node exits to the immediately downstream node in that direction. In a mesh structure the same traffic needs to be split at certain NEs so as to create redundant lightpaths in a criss-crossing mesh. These redundant lightpaths are used in dynamic restoration and/or rerouting in response to dynamic traffic conditions in the data network. They can also be used in multicast contexts. The ingress and egress nodal primitives of FIG. 1 map to such a splitting of lightpaths; their structure will be referred to herein as a “1+1 cross connect.” The intermediate node primitive of FIG. 1 maps to switching where traffic does not split into or converge from two disjoint lightpaths; its structure will be referred to herein as an “atomic cross-connect.”

In protection schemes such as that depicted in FIG. 1, the disjoint end-to-end service and protection lightpaths are found using one of the well known Shortest Path Algorithms so as to minimize the total length of each lightpath. Such a system supports a 1+1 network protection command to provision the 1+1 protected service with the following parameters:

IP address of the Ingress Node;

AID of the input port in the ingress PO node;

IP address of the Egress Node;

AID of the output port in the egress PO node;

List of nodes excluded from the service lightpath;

List of nodes excluded from the protection lightpath;

List of nodes included in the service lightpath; and

List of nodes included in the protection lightpath.

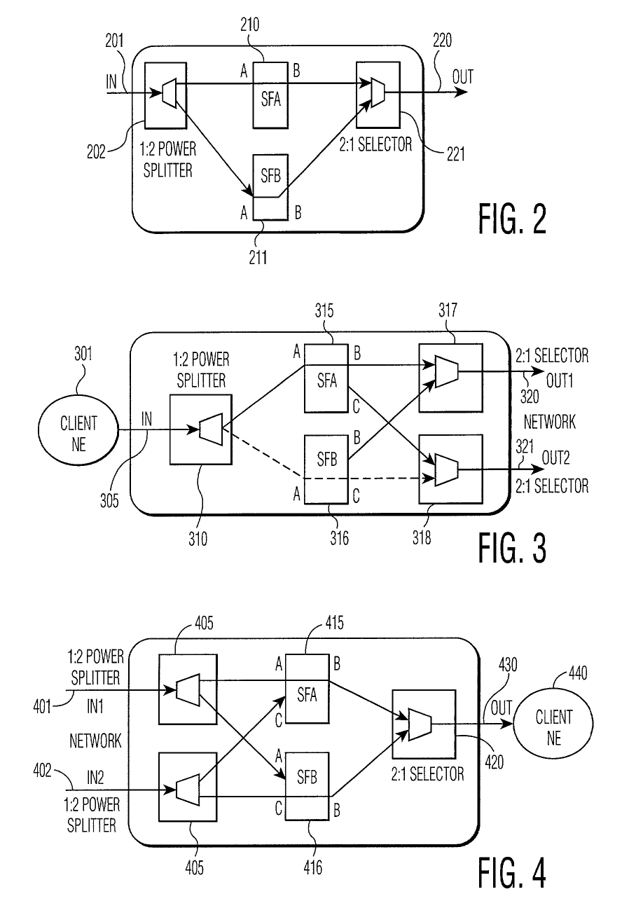

FIG. 2 illustrates an “atomic cross-connect” configuration where a signal from the input port IN 201 is split by the 1:2 power splitter 202 and sent to two redundant switching fabrics SFA 210 and SFB 211. The unidirectional atomic cross-connect connects input A with output B of each switching fabric. One of the signals is selected to be sent to output port OUT 220 with the 2:1 selector 221. Atomic cross-connects are implemented the intermediate nodes of the service and protection lightpaths 130 and 131 as shown in FIG. 1. A bidirectional atomic cross-connect is executed in both directions of transmission.

FIG. 3 illustrates a “1+1 cross-connect” in the Ingress Node of a 1+1 protected network such as the example of FIG. 1, where the signal from input port IN 305 (received from Client NE 301) is split by the 1:2 power splitter 310 and sent to the two switching fabrics SFA 315 and SFB 316. A unidirectional 1+1 cross-connect connects input A with output B of the switching fabric SFA 315. Another unidirectional 1+1 cross-connect connects input A with output C of the switching fabric SFB 316. In the default setting, the 2:1 selectors 317 and 318 are disabled from selecting the cross-connected outputs to the output ports OUT1 and OUT2, respectively, such that OUT1 320 simply passes output B of SFA 315 and OUT2 321 simply passes output C of SFB 316.

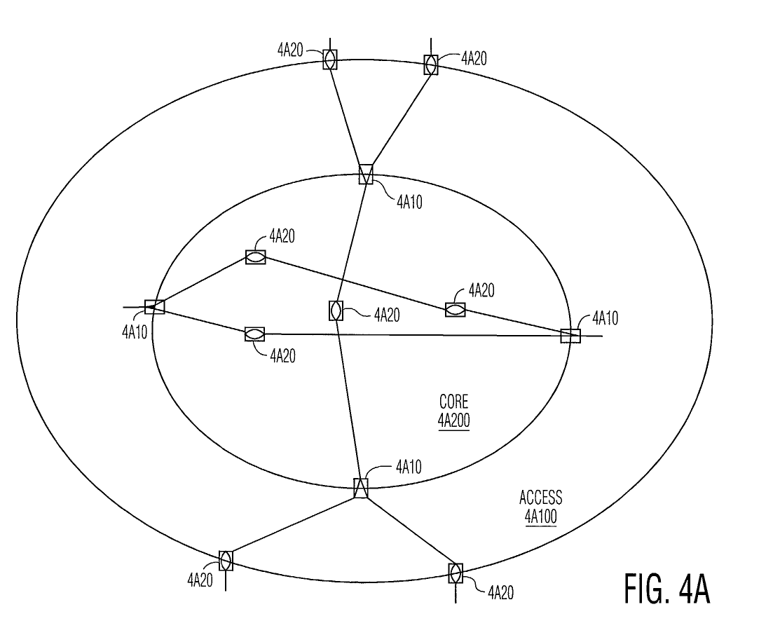

Similarly, FIG. 4 illustrates a “1+1 cross-connect” in an Egress Node of a 1+1 protected network, such as seen in FIG. 1, where two signals from the input ports IN1 401 and IN2 402 are split by the 1:2 power splitters 405 to the two switching fabrics SFA 415 and SFB 416. The unidirectional 1+1 cross-connect connects input A with output B of switching fabric SFA 415. Another unidirectional 1+1 cross-connect connects input A with output C of switching fabric SFB 416. The 2:1 selector 420 selects one of these outputs to send to output port OUT 430 which is then input to the Client NE 440. A bidirectional 1+1 cross connect is implemented simply as a combination of the shown unidirectional cross-connects, one for the ingress connection and another for the egress one.

FIG. 4A depicts an exemplary network, with a core 4A200 represented by the area within the smaller circle and an access side 4A100 represented by the area between the smaller and larger circles, whose NEs utilize the cross connect primitives presented in FIGS. 2-4. NEs which bridge access and core are implemented with bidirectional 1+1 cross connects 4A10 (combining the ingress and egress types presented in FIGS. 3 and 4), thus implementing 1+1 protection. Intermediate nodes within the core (which are on disjoint lightpaths themselves, thus not needing to be further protected), as well as client side nodes connecting to a network access node, are implemented with the atomic cross connect of FIG. 2. Multiple other configurations, depending upon where in a network multiple signals converge, split or are carried on disjoint pathways could obviously be implemented.

In addition to 1+1 network protection contexts, 1+1 cross-connects are used in 1+1 client protection, and in 1 to 2 network multicast contexts, as shall be described below.

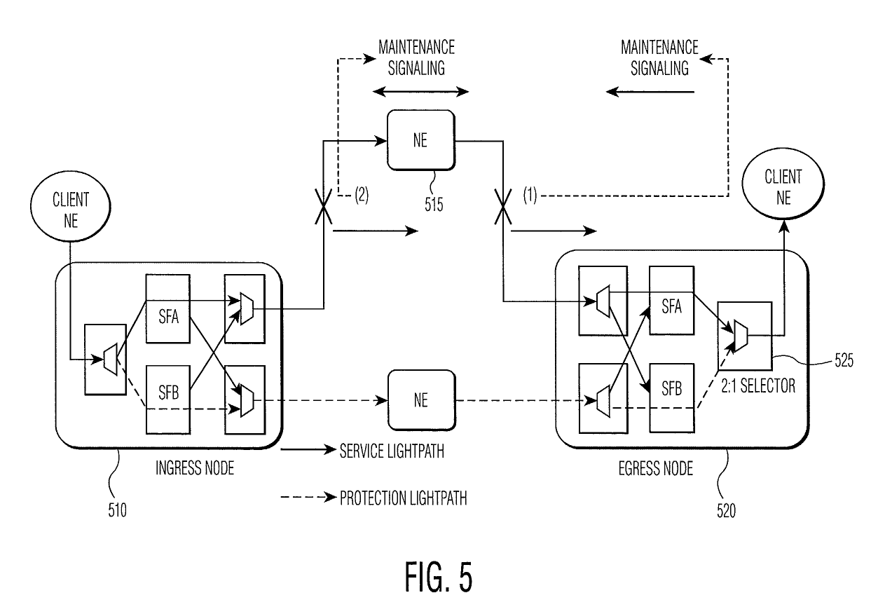

FIG. 5 depicts unidirectional failure protection of a signal transmitted by Ingress Node 510 using the 1+1 cross connects. In unidirectional 1+1 network protection, the Egress Node 520 detecting an LOP or OSNR failure (1) performs the 1+1 protection switch with the 2:1 selector 525. In bidirectional 1+1 network protection a Node detecting the LOP or OSNR failure (1) performs the 1+1 protection switch with the 2:1 selector and sends a maintenance signal in the opposite direction of transmission. The other node detects the maintenance signal and performs the 1+1 protection switch (not shown in FIG. 5).

In unidirectional 1+1 network protection an intermediate node 515 detecting the LOP or OSNR failure (2) sends a maintenance signal downstream of the failure. The signal is detected by the Egress Node 520, which then performs the 1+1 protection switch (i.e. switching form the failed lightpath to the protection lightpath) via the 2:1 selector 525. In bidirectional 1+1 network protection an intermediate node detecting the LOP or OSNR failure (2) sends one maintenance signal downstream of the failure and another in the opposite direction of transmission. The signals are detected by the Ingress/Egress Nodes that perform the 1+1 protection switches (not shown in FIG. 5).

Such maintenance signals could be implemented as inserted in-band optical signals, or as out of band messages. Besides the generation of the maintenance signal(s) by the node closest to the failure, no network level signaling is required to execute the depicted 1+1 protection.

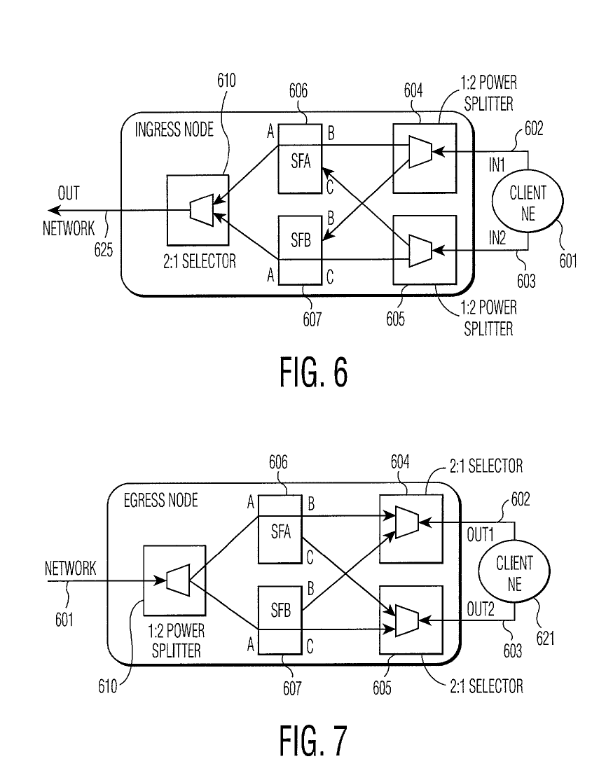

In addition to such 1+1 network protection, an optical network will optimally support 1+1 access protection at connections between an originating Client NE and the Ingress Node, and between an Egress Node and a destination Client Node. Thus, FIG. 6 depicts access protection at an ingress connection between a Client NE and an Ingress Node.

With reference to FIG. 6, two independent, identical, and diversely routed signals from the Client NE 601 are terminated by the input ports IN1 602 and IN2 603 in the Ingress Node. Each input signal is split at respective 1:2 power splitters 604, 605 and redundantly routed through SFA 606 and SFB 607 to the 2:1 selector 610. One of the input signals is selected by the 2:1 selector 610 to pass to the output port OUT 625 and on to the network. The system executes “1+1 cross-connects” to establish/tear-down the 1+1 access protection in the Ingress Node.

FIG. 7 depicts access protection at an egress connection between an Egress Node and a Client NE. The system utilizes 1+1 cross-connects to establish/tear-down the 1+1 access protection at the Egress Node. As illustrated, the Egress Node of FIG. 7 is substantially the mirror image of the Ingress Node of FIG. 6 with similar components similarly identified.

1+1 access protection is combined with 1+1 network protection or with shared network protection. According to the present invention, 1+1 access protection does not interfere with network protection. The system supports adding/deleting 1+1 access protection, regardless of the type of network protection utilized. The system of the invention supports adding/deleting 1+1 network protection, regardless whether access protection is implemented or not.

The system supports an “add 1+1 protection” command to add access or network protection. In response to such an “add” command, an unprotected service lightpath becomes a 1+1 access and/or network protected one. The input parameters of the command are, in a preferred embodiment: the lightpath ID and the list of nodes included or excluded from the protection lightpath. Conversely, the system supports a “drop 1+1 protection” command to remove 1+1 access or network protection from an existing 1+1 network and/or access protected lightpath. In a preferred embodiment the input parameters of such a command are: Lightpath ID. Sequential execution by a user of a “drop 1+1 protection” and then an “add 1+1 protection” command, after completion of a 1+1 protection switch, could be performed to replace a broken lightpath of a 1+1 network protected lightpath with a new network protected lightpath.

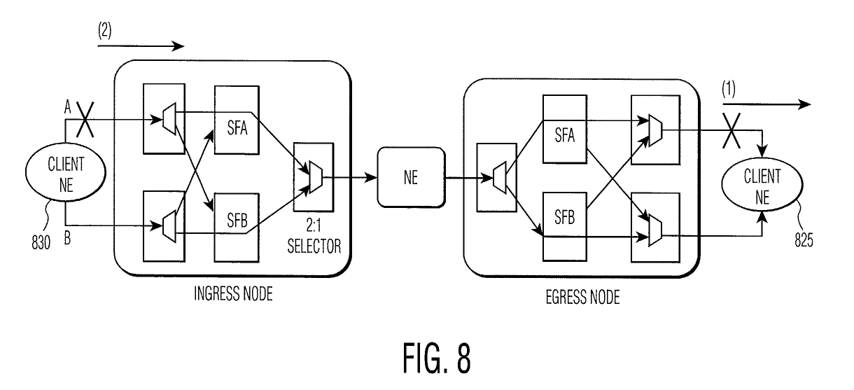

FIG. 8 illustrates combining 1+1 access protection with no network protection. In access protection of the egress connection with the Client NE 825, the Client NE 825 detecting the client-side LOP or OSNR failure (1) performs the 1+1 protection switch (i.e. switching from the failed lightpath to the protection lightpath). In access protection of the ingress connection with the Client NE 830, the Ingress Node detecting the client-side LOP or OSNR failure (2) performs the 1+1 protection switch with the 2:1 selector.

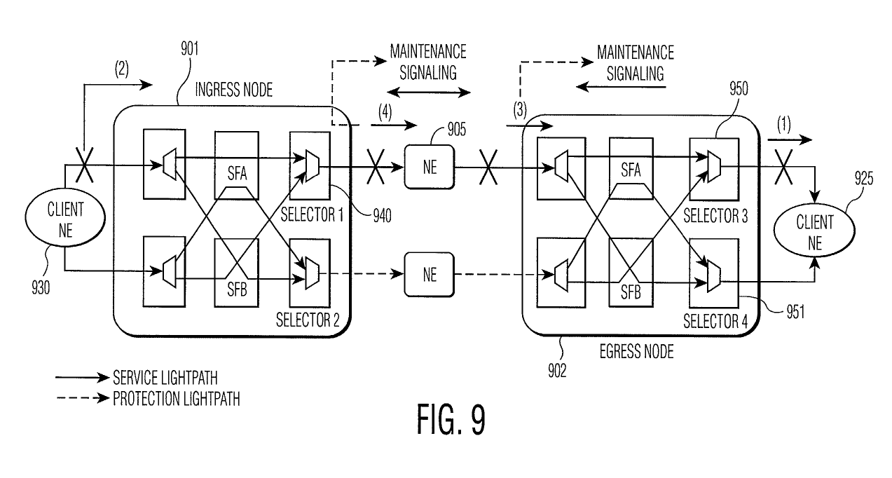

By combining the configurations of FIGS. 5 and 8, a structure emerges for combining 1+1 access protection with 1+1 network protection. In such a structure, 1+1 cross-connects are used to cross-connect switching fabrics SFA and SFB in each access node, as shown in the example of FIG. 9. This provides, as can be seen in FIG. 9, two redundant inputs and outputs at each access node, allowing identical disjoint lightpaths into, out of, and through the network.

In access protection of the egress connection with the Client NE 925, the Client NE 925 detecting the client-side LOP or OSNR failure (1) performs the 1+1 protection switch with Selector 3 950. In access protection of the ingress connection with the Client NE 930 the Ingress Node 901 detecting the client-side LOP or OSNR failure (2) performs the 1+1 protection switch with Selector 1 940.

In unidirectional 1+1 network protection, the Egress Node 902 detecting the network-side LOP or OSNR failure (3) performs the 1+1 protection switch with Selector 3 950.

In a bidirectional 1+1 network protection scheme, an Egress Node detecting the network-side LOP or OSNR failure (3) performs the 1+1 protection switch with Selector 3 950, and sends a maintenance signal in the opposite direction of transmission. The Ingress Node detects the maintenance signal and performs the 1+1 protection switch for the opposite direction of transmission (not shown).

Continuing with reference to FIG. 9, in a unidirectional 1+1 network protection implementation, an intermediate node NE 905 detecting the network-side LOP or OSNR failure (4) sends a maintenance signal downstream of the failure. The Egress Node 902 detects the signal and performs the 1+1 protection switch with Selector 3 950. In a bidirectional 1+1 network protection implementation an intermediate node NE 905 detecting the network-side LOP or OSNR failure (4) sends one maintenance signal downstream of the failure and another in the opposite direction of transmission. The downstream Egress Node 902 detects the maintenance signal and performs the 1+1 protection switch with Selector 3 950. The Ingress Node 901 detects the maintenance signal and performs the 1+1 protection switch for the opposite direction of transmission (not shown).

As described above in connection with 1+1 network protection, maintenance signaling as well as protection signals can be implemented as inserted in-band optical signals, or as out of band messages, according to techniques known or which may be known, in the art.

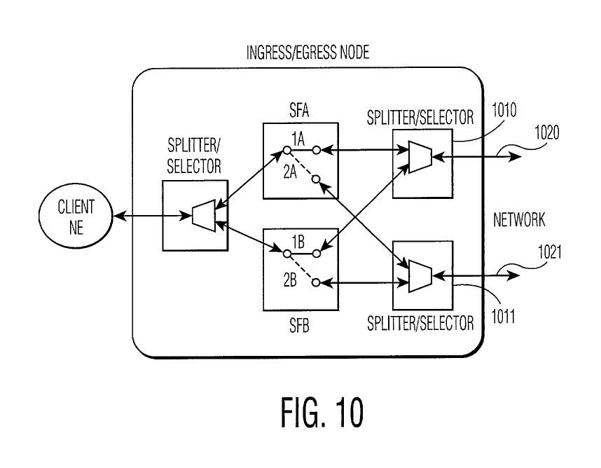

A share protected service lightpath is protected by a node and link diverse protection meta-lightpath which is cross-connected in the intermediate nodes via atomic cross-connects only at the time of the failure of the service lightpath which it protects. In the normal mode of operation the client signal travels in the service lightpath only. The atomic cross-connects of the protection meta-lightpath are stored in the path nodes. At the time of a failure, protection signaling triggers execution of the atomic cross-connects of the protection meta-lightpath and execution of the cross-connect-rolls in the Ingress and Egress Nodes of the failed service lightpath. Shared protection in accordance with the present invention will next be described with reference to FIGS. 10-14.

FIG. 10 illustrates a bidirectional cross-connect-roll. In the network's Ingress and Egress Nodes an atomic cross-connect through paths 1A and 1B is implemented in the normal mode of operation. The atomic cross-connect through paths 2A and 2B is executed in the failure mode of operation. A “cross-connect-roll” is the action of changing the atomic cross connect pathways from paths (1A,1B) to (2A,2B), or thus rerouting both signals through selector/splitters 1010 and 1011 and thus the input/output is transmitted at 1020 and 1021.

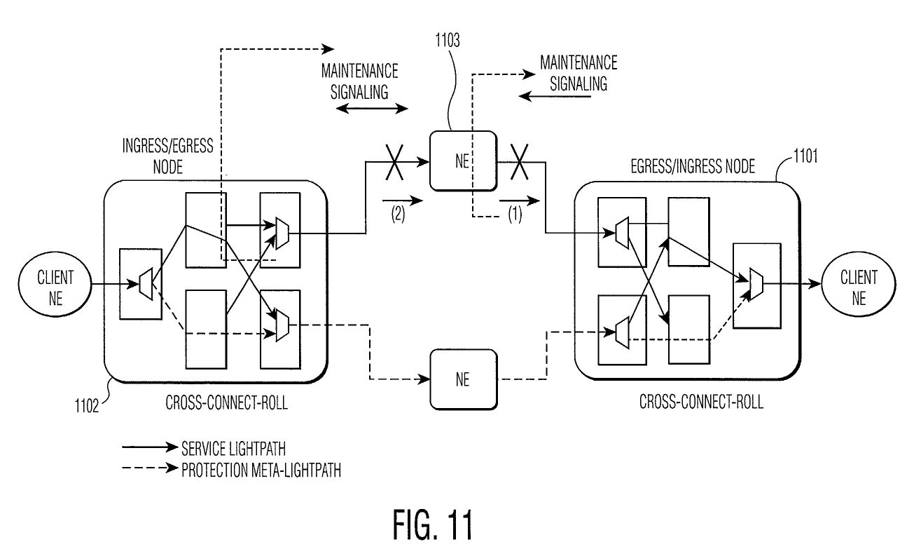

FIG. 11 illustrates shared network protection with no access protection. In unidirectional shared network protection, the Egress Node detecting the network-side LOP or OSNR failure (1) performs the cross-connect-roll protection switch to the state shown with reference to FIG. 11. The node generates a protection signal that triggers execution of the unidirectional atomic cross-connects in the nodes of the protection meta-lightpath and another cross-connect-roll protection switch in the Ingress Node 1102 of the failed unidirectional service lightpath to the state shown in FIG. 11.

In bidirectional shared network protection the Egress/Ingress Node 1101 detecting the network-side LOP or OSNR failure (1) sends a maintenance signal in the opposite direction of transmission to the Ingress/Egress Node 1102 that detects the signal. One of the Ingress/Egress Nodes that is provisioned as the initiator node performs the bidirectional cross-connect-roll protection switch and generates a protection signal that triggers (a) execution of the bidirectional atomic cross-connects in the nodes of the protection meta-lightpath and (b) execution of the bidirectional cross-connect-roll protection switch in the other Egress/ingress Node.

In unidirectional shared network protection an intermediate node 1103 detecting the network-side LOP or OSNR failure (2) sends a maintenance signal downstream of the failure. The Egress/Ingress Node 1101 detects the signal and performs the cross-connect-roll protection switch. The node generates a protection signal that triggers execution of the unidirectional atomic cross-connects in the nodes of the protection meta-lightpath and the cross-connect-roll protection switch in the Ingress Node of the failed unidirectional service lightpath.

In bidirectional shared network protection an Intermediate Node NE 1103 detecting the network-side LOP or OSNR failure (2) sends a maintenance signal in both directions of transmission to the Ingress/Egress Nodes that detect the signals. One of the Ingress/Egress Nodes that is provisioned as the initiator node performs the bidirectional cross-connect-roll protection switch. Next it generates a protection signal that triggers execution of the bidirectional atomic cross-connects in the nodes of the protection meta-lightpath and execution of the bidirectional cross-connect-roll protection switch in the other Ingress/Egress Node.

Combining 1+1 access protection with shared network on requires an “access cross-connect-roll.” FIG. 12 depicts an access cross-connect-roll executed in an Ingress Node. In the Ingress Node of FIG. 12, 1+1 cross-connects 1A and 1B are executed in the normal mode of operation, thus both input signals feed into 2:1 Selector 1201. The two signals are each one daughter signal 1220, 1221 of identical client signals 1210 and 1220, respectively, entering the node via 1:2 power splitters 1203 and 1204, respectively. The 1+1 cross-connects 2A and 2B are executed in the failure mode of operation, feeding both input signals into 2:1 Selector 1202. The input signals are now the other two daughter signals 1230, 1231 from 1:2 power splitters 1203 and 1204. The access cross-connect-roll is the action of changing the 1+1 cross connects from 1A to 2A and from 2B to 1B.

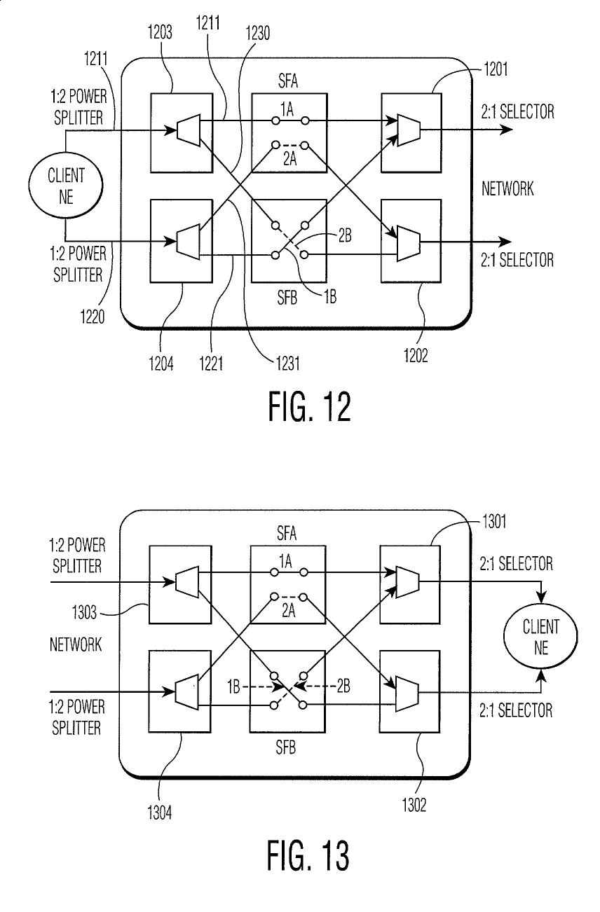

FIG. 13 depicts an access cross-connect-roll executed in an Egress Node. Similar to the Ingress Node case of FIG. 12, in the depicted Egress Node, 1+1 cross-connects 1A and 1B are executed in the normal mode of operation. This sends an identical signal to each of 2:1 Selectors 1301 and 1302 from the network side 1:2 power splitter 1303. The 1+1 cross-connects 2A and 2B are executed in the failure mode of operation, which also sends an identical signal to each of 2:1 Selectors 1301 and 1302 from the network side 1:2 power splitter 1304. The access cross-connect-roll is the action of changing the configuration of the 1+1 cross connects from 1A and 2A to 1B and 2B.

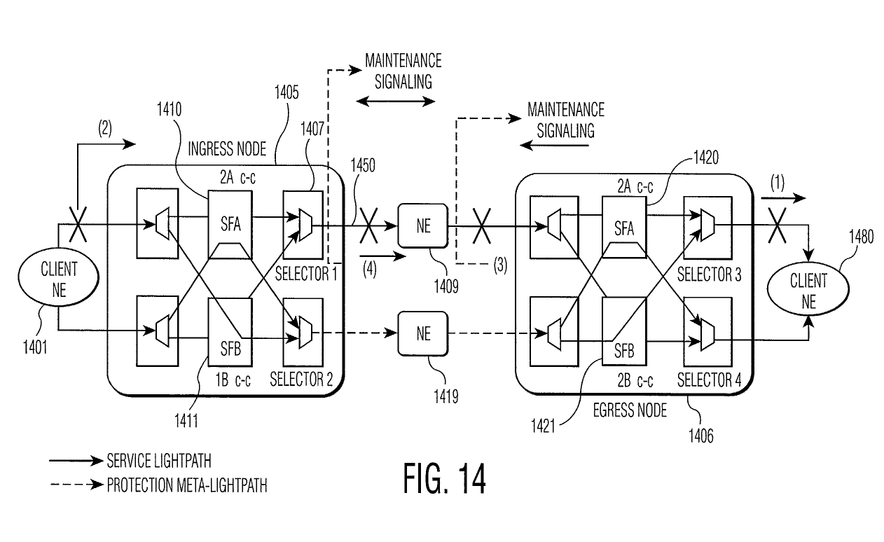

FIG. 14 illustrates the combination of 1+1 access protection with shared network protection. In this configuration, one of the two client signals from Client NE 1401 is selected to pass through the network in the service lightpath 1450. FIG. 14 shows the state of the switching fabrics SFA 1410,1420 and SFB 1411,1421 after execution of the access cross-connect-rolls in the Ingress and Egress Nodes required for network failures (3) and (4).

In access protection of the egress connection with the Client NE 1480, the Client NE 1480 detecting the client-side LOP or OSNR failure (1) performs the 1+1 protection switch. In access protection of the ingress connection with the Client NE 1401 the Ingress Node 1405 detecting the client-side LOP or OSNR failure (2) performs the 1+1 protection switch with the Selector 1 1407.

In unidirectional shared network protection the Egress Node 1406 detecting the network-side LOP or OSNR failure (3) performs the access cross-connect-roll protection switch to the state as shown, which is the protection state in FIG. 13 (2A, 2B). The node generates a protection signal that triggers execution of the unidirectional atomic cross-connects in the nodes 1410 of the protection meta-lightpath and another access cross-connect-roll protection switch in the Ingress Node 1405 of the failed unidirectional service lightpath to the state depicted in FIG. 14.

In bidirectional shared network protection the Egress/Ingress Node 1406 detecting the network-side LOP or OSNR failure (3) sends a maintenance signal in the opposite direction of transmission to the other Ingress/Egress Node that detects the signal. One of the Ingress/Nodes that is provisioned as the initiator node performs the bidirectional access cross-connect-roll protection switch and generates a protection signal that triggers execution of the bidirectional atomic cross-connects in the nodes of the protection meta-lightpath and execution of the bidirectional access cross-connect-roll protection switch in the other Ingress/Egress Node.

In unidirectional shared network protection an intermediate node 1409 detecting the network-side LOP or OSNR failure (4) sends a maintenance signal downstream of the failure. The Egress Node 1406 detects the signal and performs the access cross-connect-roll protection switch. The node 1406 generates a protection signal that triggers execution of the unidirectional atomic cross-connects in the nodes 1410 of the protection meta-lightpath and the access cross-connect-roll protection switch in the Ingress Node 1405 of the failed unidirectional service lightpath.

In bidirectional shared network protection an Intermediate Node 1409 detecting the network-side LOP or OSNR failure (4) sends a maintenance signal in both directions of transmission to the Ingress/Egress Nodes that detect the signals. One of the Ingress/Egress Nodes that is provisioned as the initiator node performs the bidirectional access cross-connect-roll protection switch and generates a protection signal that triggers execution of the bidirectional atomic cross-connects in the nodes 1410 of the protection meta-lightpath and execution of the bidirectional access cross-connect-roll protection switch in the other Ingress/Egress Node.

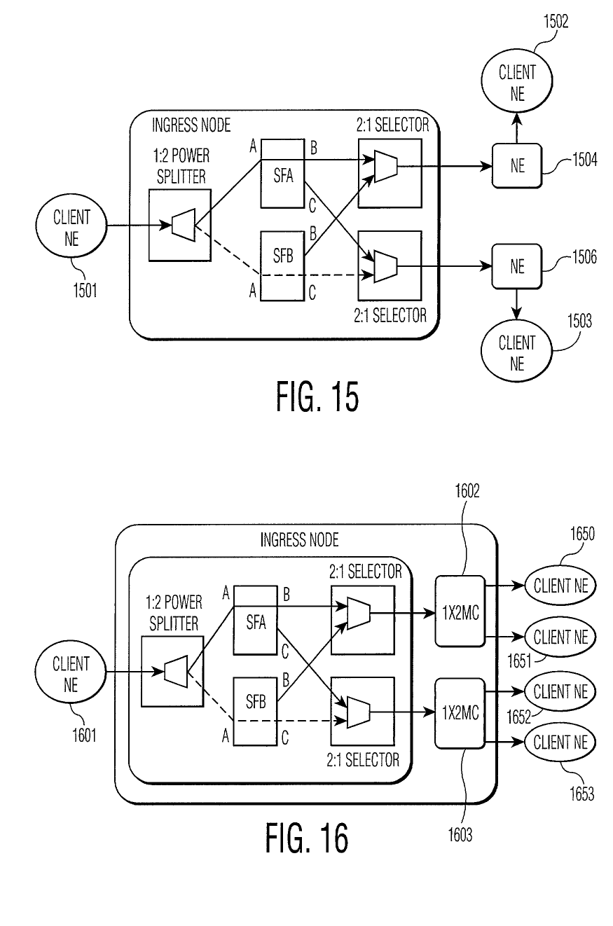

As described above, the structures of the present invention additionally lend themselves to multicast operations. In such an operation redundant signal pathways are simultaneously used to broadcast an identical original signal. FIG. 15 depicts a 1×2 multicast configuration that broadcasts a client signal from one Client NE 1501 to two other client NEs, 1502 and 1503. A 1+1 cross-connect is used for such 1×2 multicast as illustrated in FIG. 15 (essentially the same structure as depicted in FIG. 3 for an ingress node 1+1 cross-connect). Two Egress Nodes 1504 and 1506 use atomic cross-connects to pass the signals to the two Client NEs 1502 and 1503, respectively. In a preferred embodiment, the system supports a “1×2 multicast” command to provision a network bridge with the following parameters:

IP address of the Ingress Node;

AID of the input port in the Ingress Node;

IP address of the first Egress Node;

AID of the output port in the first Egress Node;

IP address of the second Egress Node;

AID of the output port in the second Egress Node;

List of nodes excluded from the first lightpath;

List of nodes included in the first lightpath;

List of nodes excluded from the second lightpath; and

List of nodes included in the second lightpath.

In a preferred embodiment the system also supports a “delete 1×2 multicast” command with the input parameter: Lightpath ID.

Extending the multicast operation, FIG. 16 illustrates a 1×4 multicast configuration that broadcasts a client signal from one Client NE 1601 to ultimately four other Client NEs 1650-1653. In order to achieve 1×4 multicast, three 1×2 multicasts are performed; a first 1×2 MC in the Ingress Node, as depicted in FIG. 15, and then each multicast recipient 1602 and 1603 additionally performs its own 1×2 multicast.

While the above describes the preferred embodiments of the invention, various modifications or additions will be apparent to those of skill in the art. Such modifications and additions are intended to be covered by the following claims.

What is claimed:

1. A switching device for data network elements, comprising:
N input ports;
N 1:2 power splitters;
two N×N switching fabrics;
N 2:1 selectors; and
N output ports,
where N is a positive integer.

2. The device of claim 1, where each input port is connected to a 1:2 power splitter, the two outputs from each said power splitter are connected to a 2:1 selector, and each output is taken from the output side of one of said 2:1 selectors.

3. A switching device for data network elements, comprising:
N input ports;
N 1:2 power splitters;
two N×N switching fabrics;
2N 2:1 selectors; and
2N output ports.
where N is a positive integer.

4. The device of claim 3, where each input port is connected to a 1:2 power splitter, the two outputs from each said power splitter are connected one to each of said two N×N switching fabrics, and one output from each of said switching fabrics is connected to the input side of one of said 2:1 selectors.

5. A switching device for data network elements, comprising:
2N input ports;
2N 1:2 power splitters;
two N×N switching fabrics;
N 2:1 selectors; and
N output ports.
where N is a positive integer.

6. The device of claim 5, where each input port is connected to a 1:2 power splitter, the two outputs from each said power splitter are connected one to each of said two N×N switching fabrics, and one output from each of said switching fabrics is connected to the input side of one of said 2:1 selectors.

7. A method of implementing 1+1 network protection comprising:
using the device of claim 3 in ingress nodes;
using the device of claim 5 in egress nodes; and
using the device of claim 1 in intermediate nodes.

8. A method of implementing 1+1 network protection comprising:
using the device of claim 4 in ingress nodes;
using the device of claim 6 in egress nodes; and
using the device of claim 2 in intermediate nodes.

9. The method of either of claims 7 or 8, further comprising:
in the event of a detected LOP or unacceptable OSNR condition,
switching to a protection lightpath and signaling other network nodes.

10. The method of claim 9, where the network protection is implemented in a mesh network, and the ingress and egress nodes bridge the core and access portions of the network, with the core side having two lightpaths connecting to the node and the access side one lightpath connecting to the node.

11. The method of claim 10, where each ingress node is also an egress node, and each egress node is also an ingress node.

12. The method of claim 11, where intermediate nodes are those that are neither ingress nodes, egress nodes, nor both.

13. A cross-connect building block, comprising:
an input port;
a 1:2 power splitter;
two switching fabrics;
a 2:1 selector; and
an output port.

14. An ingress cross-connect building block, comprising:
an input port;
a 1:2 power splitter;
two switching fabrics;
two 2:1 selectors; and
two output ports.

15. An egress cross-connect building block, comprising:
two input ports;
two 1:2 power splitters;
two switching fabrics;
a 2:1 selector; and
an output port.

16. A bidirectional ingress/egress cross-connect building block, comprising:
the device of claim 14; and
the device of claim 15.

17. A bidirectional switching device for network elements, comprising:
the device of claims 3 or 4; and
the device of claims 5 or 6.

18. A method of implementing 1×2 multicasting, comprising:
utilizing the device of claim 14 to take an input signal from a client network element and output a copy on each of the two output ports.

19. The method of claim 18 where the 2:1 selectors select signals coming from different switching fabrics.

20. A method of implementing 1×4 multicasting, comprising:
utilizing the method of claims 18 or 19 twice in succession.

21. An ingress cross-connect building block, comprising:
two input ports;
two 1:2 power splitter;
two switching fabrics;
a 2:1 selector; and
an output port.

22. An egress cross-connect building block, comprising:
one input port;
a 1:2 power splitter;
two switching fabrics;
two 2:1 selectors; and
two output ports.

23. A method of implementing 1+1 access protection in a data network, comprising:
using the device of claim 21 in ingress nodes;
using the device of claim 22 in egress nodes; and
using the device of claim 13 in intermediate nodes.

24. An ingress cross-connect building block, comprising:
two input ports;
two 1:2 power splitters;
two switching fabrics;
two 2:1 selectors; and
two output ports.

25. An egress cross-connect building block, comprising:
two input ports;
two 1:2 power splitters;
two switching fabrics;
two 2:1 selectors; and
two output ports.

26. A method of implementing 1+1 network and access protection in a data network, comprising:
using the device of claim 24 in ingress nodes;
using the device of claim 25 in egress nodes; and
using the device of claim 13 in intermediate nodes.

27. The method of claim 26, where there are two disjoint pathways through the network comprised of intermediate nodes.

28. A switching device for data network elements, comprising:
2N input ports;
2N 1:2 power splitters;
two N×N switching fabrics;
2N 2:1 selectors; and
2N output ports.
where N is a positive integer.

29. The device of claim 28, where each input port is connected to a 1:2 power splitter, the two outputs from each of said power splitters are connected one to each of said two N×N switching fabrics, and one output from each of said switching fabrics is connected to the input side of one of said 2:1 selectors.

30. A switching device for data network elements, comprising:
2N input ports;
2N 1:2 power splitters;
two N×N switching fabrics;
2N 2:1 selectors; and
2N output ports.
where N is a positive integer.

31. The device of claim 30, where each input port is connected to a 1:2 power splitter, the two outputs from each said power splitter are connected one to each of said two N×N switching fabrics, and one output from each of said switching fabrics is connected to the input side of one of said 2:1 selectors.

32. A method of implementing 1+1 network and access protection in a data network, comprising:
using the device of claim 28 in ingress nodes;
using the device of claim 30 in egress nodes; and
using the device of claim 1 in intermediate nodes.

33. The method of claim 32, where there are two disjoint pathways through the network comprised of intermediate nodes.
